(19) United States
(12) Patent Application Publication
(10) Pub. No.: US 2005/0130096 A1
(43) Pub. Date: Jun. 16, 2005

(54) Orthodontic bracket packaging kits and systems

(75) Inventors: Gary Stout, Bountiful, UT (US); Dan E. Fischer, Sandy, UT (US); Bruce S. McLean, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: ULTRADENT PRODUCTS, INC., South Jordan, UT (US)

(21) Appl. No.: 11/045,165

(22) Filed: Jan. 28, 2005

Related U.S. Application Data
(62) Division of application No. 10/627,086, filed on Jul. 25, 2003.

(51) Int. Cl. A61C 3/00

(52) U.S. Cl. 433/24

(57) ABSTRACT

An orthodontic bracket packaging kit and system includes a base tray, a plurality of pedestals for supporting individual orthodontic brackets, and a protective lid. The kit may also include a blister cover fitting over the orthodontic brackets, helping to hold them in place on top of the individual pedestals. The base tray may have an undulating profile defining a lower level and an upper level, along with a tongue raised towards the lower level. The upper level may be used for placement of maxillary brackets, while the lower level may hold mandibular brackets. The pedestals may be arranged along the base tray in a staggered, radial arc arrangement to facilitate manual retrieval of the brackets. The protective cover may be substantially opaque to curing light wavelengths to protect light curable adhesive pre-applied to the individual brackets.

### CROSS-REFERENCE TO RELATED APPLICATIONS

This application is a divisional of U.S. application Ser. No. 10/627,086, filed Jul. 25, 2003 and entitled, “ORTHODONTIC BRACKET PACKAGING KITS AND SYSTEMS.” For purposes of this disclosure, the foregoing application is incorporated herein by reference.

### BACKGROUND OF THE INVENTION

1. The Field of the Invention

The present invention relates to packaging kits and systems for orthodontic brackets.

2. The Relevant Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth to correct underbites or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces”. Orthodontic brackets, more particularly the bracket bases, are small slotted bodies configured for direct attachment to the patient's teeth. Once the brackets are affixed to the patient's teeth, such as by means of glue or cement, a curved arch wire is inserted into the slot of each bracket. The arch wire acts as a template or track to guide movement of the teeth into proper alignment. End sections of the arch wire are typically captured within tiny appliances known as “buccal tubes” affixed to the patient's molars.

Various kits and systems have been devised in order to package orthodontic brackets prior to placement. U.S. Pat. No. 5,542,844 to Perret discloses a disposable orthodontic bracket pad having a top and bottom sheet. The top sheet is formed of a water impervious material, and has a plurality of openings for placement of individual brackets. The bottom sheet includes an adhesive for holding the brackets, which may be arranged in the shape of an arch to mimic the arrangement of teeth.

Various other packaging systems, for example U.S. Pat. Nos. 4,978,007, 4,979,611, and 5,538,129, also disclose packaging kits that include a pocket or pockets for storing orthodontic brackets.

The various existing orthodontic bracket packaging systems are often difficult to use, may not sufficiently protect the brackets from damage, and sometimes make identification of individual brackets confusing or difficult. Therefore, there exists a need for a packaging kit and system that can simplify the storage, identification, and installation of orthodontic brackets.

### BRIEF SUMMARY OF THE INVENTION

The present invention is directed to packaging kits and systems for orthodontic brackets. The kit is designed to provide a simple packaging kit, while assisting the orthodontic practitioner in quickly identifying individual brackets and retrieving them for placement onto a patient's teeth.

The packaging kit includes a base tray, a plurality of pedestals formed on the base tray, and a protective lid for covering the base tray and pedestals. According to one embodiment, the base tray includes an undulating profile so as to define an upper level and a lower level. Orthodontic brackets intended to be placed on teeth of the maxillary dental arch are stored on pedestals of the upper level, while brackets intended for placement on teeth of the mandibular arch are stored on pedestals of the lower level. The pedestals may be formed along the base tray in a staggered, radial arc arrangement to facilitate manual retrieval of individual orthodontic brackets.

According to one embodiment, the kit may also include a blister cover configured to fit over the orthodontic brackets and pedestals. Such a cover helps hold each individual bracket on its designated pedestal. In addition, the brackets may have an adhesive pre-applied (e.g. a light curable adhesive resin) so as to allow the bracket to temporarily bond to its designated pedestal. In one embodiment, the adhesive is such that it remains adhered to the pedestal when the orthodontic practitioner removes the bracket from the pedestal. In other words, the separation occurs between the bracket and the adhesive. In an alternative embodiment, the adhesive is formulated to remain adhered to the bracket, the separation occurring between the adhesive and the pedestal. In such an embodiment the adhesive may then be used to bond the bracket to the patient's tooth.

According to one embodiment, all parts of the packaging kit, including the base tray, the protective lid, the pedestals, and the blister cover may be formed of an inexpensive plastic material. Individual parts may be injection molded or manufactured through other methods known in the art. It may be desirable to mold the base tray and plurality of pedestals as one piece. The protective lid and blister cover may be formed separately, and one or both may be formed of a composition so as to be substantially opaque to curing wavelengths.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A is an exploded view of an exemplary orthodontic bracket packaging kit;

FIG. 1B is a cross-section view of a portion of the exemplary orthodontic bracket packaging kit illustrated in FIG. 1A;

FIG. 2 is a perspective view of the exemplary orthodontic bracket packaging kit illustrated in FIG. 1A, but in an assembled configuration;

FIG. 3 is a perspective view of an orthodontic practitioner manually retrieving a bracket from an opened orthodontic bracket packaging kit.

### DETAILED DESCRIPTION OF THE PREFERRED EMBODIMENTS

I. Introduction

A detailed description of the invention will now be provided with specific reference to figures illustrating preferred embodiments of the invention. It will be appreciated that like structures will be provided with like reference designations. To provide context for interpreting the scope of the invention, certain terms used throughout the application will now be defined.

As used herein, the term “curing light wavelength” refers to light that is monochromatic or substantially monochromatic, as well as light that falls within a range of wavelengths. The term refers to either the actual wavelength of monochromatic light or the dominant wavelength within a range of wavelengths.

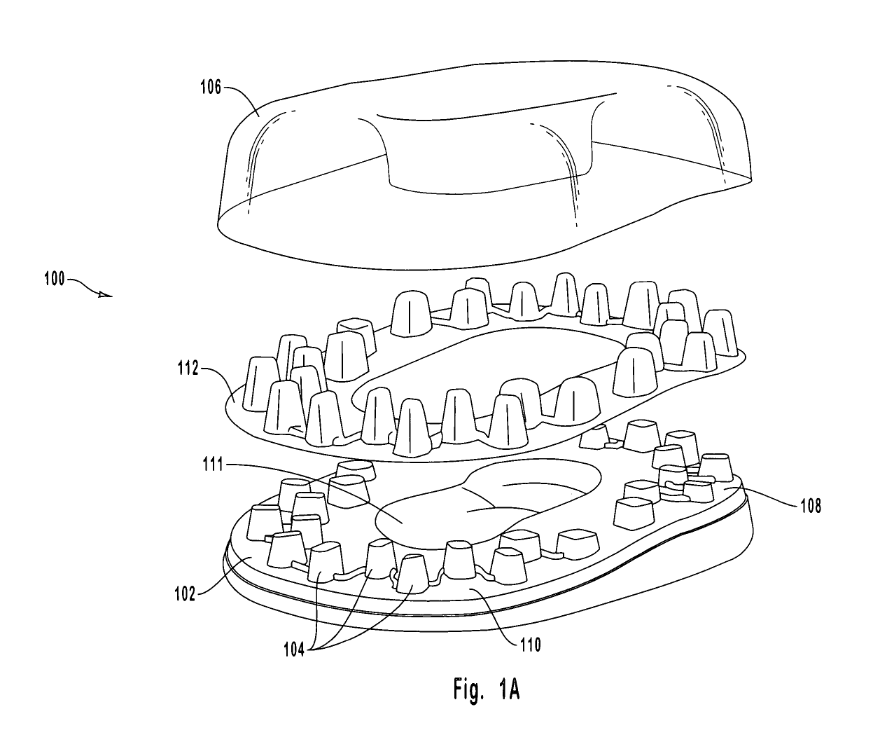

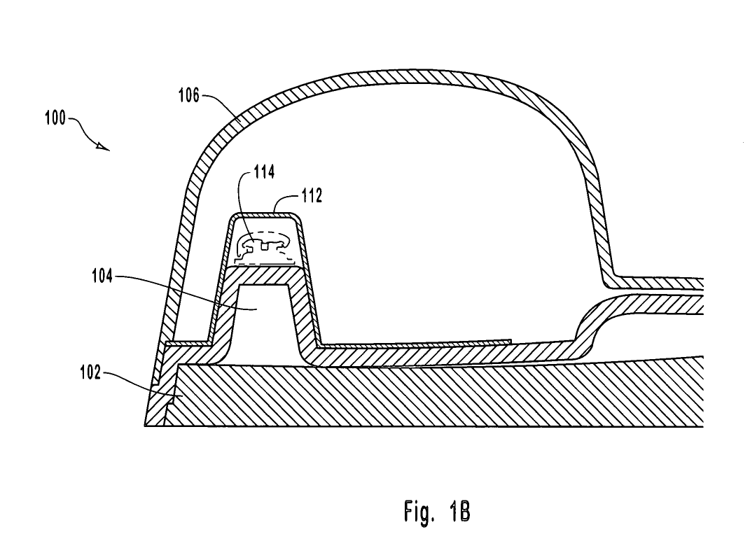

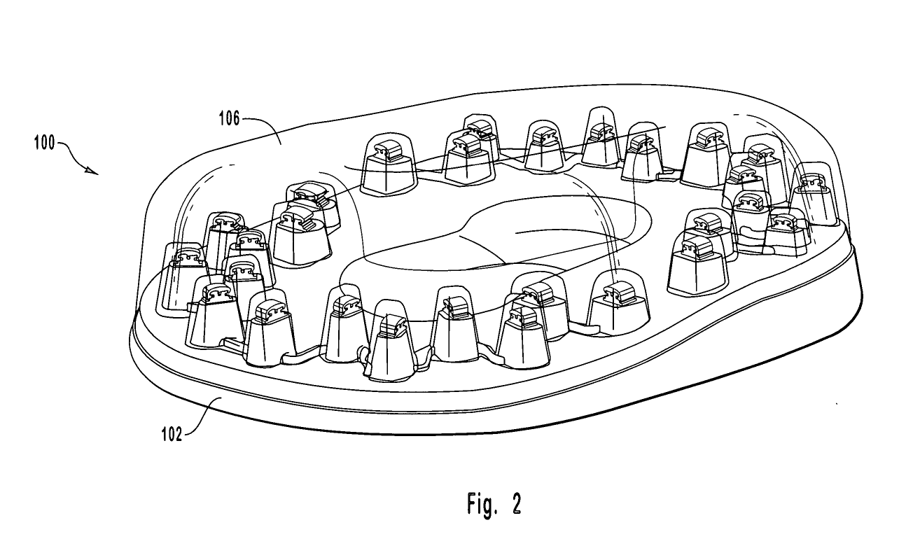

The present invention is directed to packaging kits and systems for orthodontic brackets. The kit is designed to provide an easy to use packaging kit, while assisting the orthodontic practitioner in quickly identifying individual brackets and retrieving them for placement. FIGS. 1A, 1B, and 2 illustrate an exemplary embodiment of the orthodontic packaging kit 100. The packaging kit includes a base tray, a plurality of pedestals formed on the base tray, and a protective lid for covering the base tray and pedestals. The kit may also optionally include a blister cover.

II. Exemplary Orthodontic Bracket Packaging Kit

FIG. 1A is an exploded view of an exemplary orthodontic bracket packaging kit. The kit 100 includes a base tray 102, pedestals 104, and protective lid 106. Pedestals 104 may be formed on the base tray 102, while protective lid 106 is designed to fit over base tray 102 and pedestals 104 so as to protect individual orthodontic brackets placed on the pedestals.

A. Base Tray

According to one embodiment, the base tray 102 includes an undulating profile so as to define an upper level 108 and a lower level 110. The base tray 102 may also include a tongue replica 111. The tongue replica 111, in conjunction with the upper level 108 and the lower level 110, aids the orthodontic practitioner in identifying the location of particular orthodontic brackets. The base tray 102 may be formed through injection molding or other plastic molding techniques as known in the art.

B. Pedestals

Pedestals 104 are located on the base tray 102, and may be formed with the base tray 102 as a single piece through injection molding or other manufacturing methods. As perhaps best seen in FIG. 1B, the base tray 102 and the pedestals 104 may be molded in such a way so as to leave voids within the molding material in order to reduce cost and weight. According to one embodiment, the pedestals 104 are arranged on the upper and lower levels 108, 110 of the base tray in a staggered, radial arc arrangement. As replica tongue 111 is raised towards lower level 108, it helps in quickly identifying the levels to the orthodontic practitioner. This arrangement of levels and pedestals facilitates easy identification of individual brackets, while also providing the orthodontic practitioner with easy access to each individual bracket. The staggered, radial arc arrangement mimics the positions of a patient's teeth along the dental arches. In this way, the orthodontic practitioner can easily identify which bracket is associated with any particular tooth, and then easily retrieve the desired bracket.

C. Protective Lid

Kit 100 includes protective lid 106, which fits over and protects the orthodontic brackets stored within the kit 100. The protective lid 106 may be formed of a plastic material that may be opaque, transparent, or translucent. According to one embodiment, the material may be colored so as to be at least substantially opaque to curing wavelengths. For example, the protective lid 106 may have a UV Orange tint so as to be substantially opaque to curing light having wavelengths between about 400 and 500 nm. Making the protective lid 106 substantially opaque to curing light wavelengths allows brackets to be stored in the packaging kit 100 with a light activated adhesive pre-applied to the bracket bases. The opacity of the lid 106 prevents wavelengths that would otherwise cure the adhesive from reaching any pre-applied adhesive layer.

D. Blister Cover

Kit 100 may optionally include a blister cover 112. The blister cover may be formed of a thin plastic material. It may be opaque, transparent or translucent, and, like the protective lid, may be colored so as to be substantially opaque to curing wavelengths. Referring to FIG. 1B, the blister cover 112 may be positioned over the pedestals 104 and brackets 114. The blister cover is configured so as to form a housing around the bracket 114 and pedestal 104, securely retaining the bracket on top of pedestal 104.

III. Exemplary Method of Use

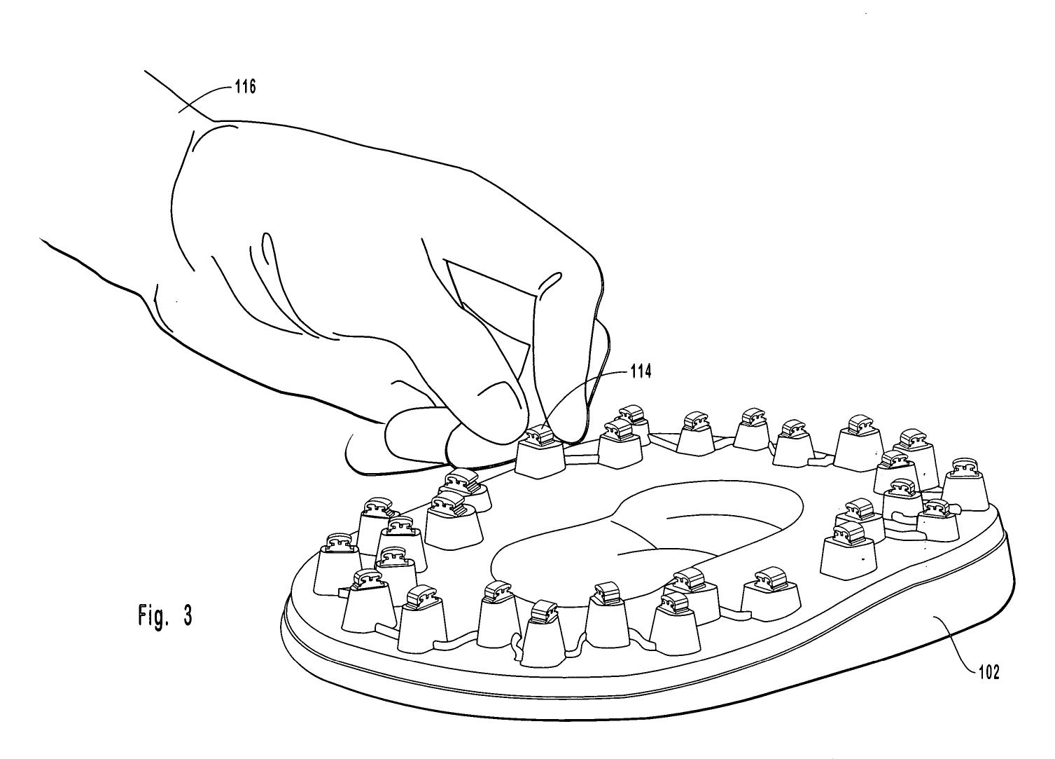

The packaging kit 100 may be used to package and store a plurality of orthodontic brackets 114. The packaging kit allows individual brackets 114 to be placed on top of pedestals 104. Because of the packaging kit's configuration, the orthodontic practitioner is able to determine which bracket is associated with any particular tooth by simply by looking at the packaging kit. Once the protective lid 106 and blister cover 112 are removed, the staggered spacing and radial arc arrangement of the individual pedestals 104 allows the orthodontic practitioner 116 to easily retrieve a desired bracket 114 without disturbing adjacent brackets, as illustrated in FIG. 3. The bracket 114 may then be bonded to the appropriate tooth using either a pre-applied adhesive, or by applying an adhesive at that time.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A method of installing one or more orthodontic brackets comprising:
providing a packaging kit for orthodontic brackets comprising:
a base tray;
a plurality of pedestals formed on said base tray, each pedestal configured to support an orthodontic bracket;
a protective lid for covering said base tray and said plurality of pedestals; and
a plurality of orthodontic brackets, each bracket supported on top of one of said pedestals;
retrieving one or more of said orthodontic brackets from said pedestals; and
bonding said one or more orthodontic brackets to a patient's teeth.

2. A method as recited in claim 1, wherein each orthodontic bracket includes a pre-applied light curable adhesive.

3. A method as recited in claim 2, further comprising curing said light curable adhesive.
